(19) United States
(12) Patent Application Publication
(10) Pub. No.: US 2026/0205793 A1
(43) Pub. Date: Jul. 16, 2026

(54) SUBSCRIPTION-BASED TELEMETRY IN WIRELESS NETWORKS

(71) Applicant: Cisco Technology, Inc., San Jose, CA (US)

(72) Inventors: Domenico FICARA, Essertines-Sur-Yverdon (CH); Federico LOVISON, Fontanelle (IT); Ugo M. CAMPIGLIO, Morges (CH); Javier I. CONTRERAS ALBESA, Sant Cugat del Valles (ES); Juan Carlos ZUNIGA, Montreal (CA)

(21) Appl. No.: 19/366,485

(22) Filed: Oct. 22, 2025

Related U.S. Application Data
(60) Provisional application No. 63/738,731, filed on Dec. 24, 2024.

(51) Int. Cl. H04W 8/00; H04L 5/00; H04W 8/20

(52) U.S. Cl. CPC H04W 8/005; H04L 5/0053; H04W 8/20

(57) ABSTRACT

The present disclosure provides techniques for establishing and managing subscription- based telemetry in wireless networks. An access point (AP) receives a discovery frame from a client device requesting information on subscribable data sources, transmits a discovery response frame identifying one or more data sources supported by the first AP, each data source being associated with one or more subscription types, receives a subscription request frame from the client device, the subscription request frame identifying one or more selected data sources, each selected data source being associated with a respective selected subscription type, transmits an acknowledgement frame to the client device, the acknowledgement frame comprising an approval of the subscription request frame and a subscription identifier assigned to the client device, and sends data from the selected data sources to the client device based on the respective selected subscription types.

### CROSS-REFERENCE TO RELATED APPLICATIONS

This application claims benefit of co-pending United States provisional patent application Serial No. 63/738,731 filed December 24, 2024. The aforementioned related patent application is herein incorporated by reference in its entirety.

### TECHNICAL FIELD

Embodiments presented in this disclosure generally relate to wireless communication. More specifically, embodiments disclosed herein relate to establishing and managing subscription-based telemetry in wireless networks.

### BACKGROUND

The evolution of IEEE 802.11 has progressively introduced new services and capabilities for stations (STAs), many of which rely on increasingly complicated information sharing between an access point (AP) and the associated STAs. For example, amendments such as 802.11bn and 802.11bi provide new messaging mechanisms to support future use cases that involve artificial intelligence (AI) and machine learning (ML) applications. These use cases may require the efficient collection and exchange of telemetry information between an AP and associated STAs.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example extended service set (ESS) with subscription-based telemetry established between access points (APs) and stations (STAs) or between peer STAs, according to some embodiments of the present disclosure.

FIG. 2 depicts an example interaction sequence between a STA and an AP for establishing subscription-based telemetry, according to some embodiments of the present disclosure.

FIG. 3 depicts an example interaction sequence between a STA and an AP when a subscription is temporarily suspended and subsequently resumed, according to some embodiments of the present disclosure.

FIG. 4 depicts an example interaction sequence between a STA and an AP for terminating a subscription, according to some embodiments of the present disclosure.

FIGS. 5A and 5B depict an example method performed by an AP for establishing and managing subscription-based telemetry, according to some embodiments of the present disclosure.

FIG. 6 is a block diagram depicting an example method for subscription-based telemetry establishment, according to some embodiments of the present disclosure.

FIG. 7 depicts an example network device configured to perform various aspects of the present disclosure, according to some embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including receiving, by an access point (AP), a discovery frame from a client device requesting information on subscribable data sources, transmitting, by the AP, a discovery response frame identifying one or more data sources supported by the AP, each data source being associated with one or more subscription types, receiving, by the AP, a subscription request frame from the client device, the subscription request frame identifying one or more selected data sources, each selected data source being associated with a respective selected subscription type, transmitting, by the AP, an acknowledgement frame to the client device, the acknowledgement frame comprising an approval of the subscription request frame and a subscription identifier assigned to the client device, and sending, by the AP, data from the selected data sources to the client device based on the respective selected subscription types.

Other embodiments in this disclosure provide one or more non-transitory computer-readable media containing, in any combination, computer program code that, when executed by operation of a computer system, performs operations in accordance with one or more of the above methods, as well as a system of a network device comprising one or more computer processors, and one or more memories collectively containing one or more programs, which, when executed by the one or more computer processors, perform operations in accordance with one or more of the above methods.

### Example Embodiments

The IEEE 802.11 standard has continued to evolve to address the increasing demand for wireless services. Recent amendments introduce new signaling and coordination mechanisms intended to support emerging use cases, including applications that use artificial intelligence (AI) and machine learning (ML). Such use cases often depend on efficient collection and exchange of telemetry information between an access point (AP) and associated station (STAs), or directly between peer STAs.

Conventional approaches to monitoring and information exchange in wireless networks are largely limited to polling-based mechanisms, which require a monitoring entity to repeatedly request statistics or event data from the AP or STA. The polling-based mechanisms introduce inefficiencies, unnecessary traffic overhead, and scalability challenges, particularly when many devices need to be monitored simultaneously or when the information is needed in near real-time.

Embodiments of the present disclosure introduce methods, systems, and apparatus for establishing and managing subscription-based telemetry in wireless networks. The disclosed techniques may be applied between an AP and one or more STAs, or between peer STAs in direct communication. The subscription framework may be symmetrical, allowing either party (e.g., STA or AP) to act as a publisher and the other to act as a subscriber.

In embodiments where the AP serves as the publisher, the workflow begins with a discovery exchange. The STA transmits a discovery frame, and the AP responds with a list of available data sources and their associated subscription types (e.g., periodic subscriptions, on-change or event-triggered subscriptions, mixed models, or AP-suggested subscriptions). The STA then transmits a subscription request identifying one or more selected data sources along with the subscription types to be applied. The AP responds with an acknowledgement frame that either approves or rejects the request, and assigns a subscription identifier when approved. Once the subscription is established, the AP proceeds to publish (or transmit) data from the selected sources to the STA, with publishing behavior determined by the selected subscription type.

In some embodiments, the AP may temporarily suspend publishing (or transmission). For example, the AP may transmit a suspension frame to the STA identifying a subscription to be temporarily suspended, such as when a data source becomes unavailable or when system load exceeds a threshold. The suspension frame may specify the affected subscription identifier (ID), the expected suspension duration, and one or more reasons for the suspension. Upon resolution of the condition, the AP may resume publishing (or transmission) in accordance with the subscription.

In some embodiments, a subscription may be terminated. Termination may occur when the STA disassociates from the AP’s basic service set (BSS), when the STA explicitly unsubscribes by sending an unsubscribe request frame, when a subscription duration specified in the subscription request expires, or when the AP transmits a termination notification including a reason code such as permanent, long-term, or indefinite unavailability of a data source.

The disclosed subscription-based telemetry framework reduces signaling overhead, enables fine-grained and selective delivery of telemetry data, and facilitates support for use cases including AI/ML-driven optimization and Internet-of-Things (IoT) device management. In addition, the framework supports flexible implementation features, such as filtering, buffering, multicast delivery without exposing personally identifiable information, power-saving awareness, and bitmap-based multiplexing of multiple subscriptions.

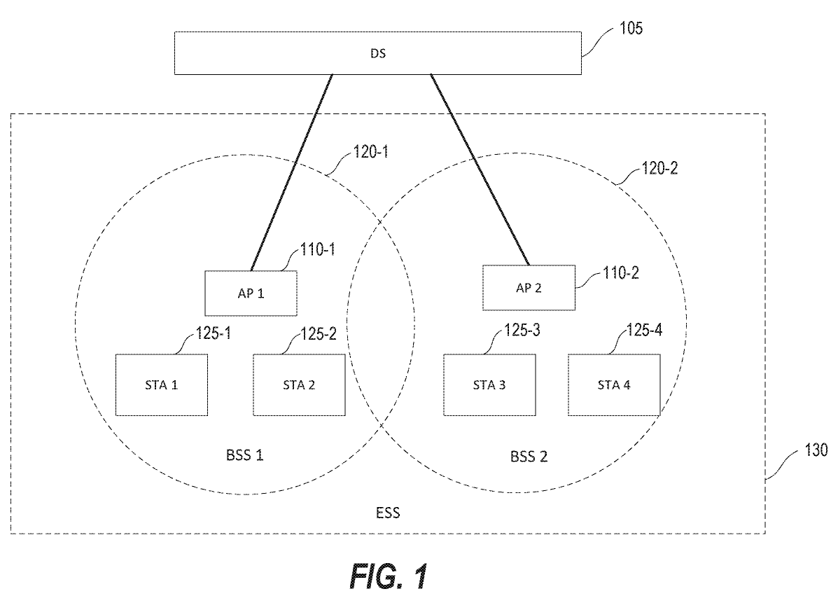

FIG. 1 depicts an example extended service set (ESS) 130 with subscription-based telemetry established between access points (APs) and stations (STAs) or between peer STAs, according to some embodiments of the present disclosure.

As depicted, the example ESS 130 includes two basic service sets, BSS 1 and BSS 2. A distribution system (DS) 105 interconnects the two APs, AP 1 (110-1) and AP 2 (110-2). Each AP serves as the coordination of its respective BSS. BSS 1 includes AP 1 (110-1), which is connected to STA 1 (125-1) and STA 2 (125-2). BSS 2 includes AP 2 (110-2), which is connected to STA 3 (125-3) and STA 4 (125-4). Each BSS provides a logical wireless coverage area under control of its AP. As illustrated, the communication scope of BSS 1 is represented by 120-1, and the communication scope of BSS 2 is represented by 120-2.

The DS 105 enables communication and mobility between AP 1 and AP 2, and the DS 105 supports seamless roaming across BSS 1 and BSS 2 to form ESS 130. In some embodiments, the AP may be implemented as a single-link AP or as a multi-link device (AP MLD). In some embodiments, each STA may be implemented as a single-link STA or a multi-link device (STA MLD).

In the depicted ESS 130, STA 1 (125-1) may support applications that are sensitive to network conditions, such as real-time communication, streaming media, or industrial IoT control. To operate efficiently, STA 1 may rely on efficient and timely updates from AP 1 (110-1) regarding channel conditions, interference levels, or network load, so that STA 1 can adapt its communication parameters or determine whether to roam to another AP. Conventional approaches to obtaining such information typically rely on polling mechanisms, where the STA or network management system has to repeatedly request status information. Therefore, the polling mechanisms consume additional bandwidth, introduce inefficiencies, and cannot provide the timely responsiveness needed for applications with strict performance requirements.

Subscription-based telemetry may therefore be needed (or preferred). For example, STA 1 (125-1) may subscribe to periodic updates about AP load or to event-driven alerts about congestion, allowing STA 1 to balance throughput and latency for its active applications. As used herein, telemetry refers to information exchanged for monitoring, optimization, and decision-making. Subscription-based telemetry ensures that the subscriber obtains the specific information it requires, when it is relevant, without the overhead of repeated polling. In this example, when a subscription is established, STA 1 may receive telemetry from AP 1 in accordance with the subscription parameters.

In addition to the STA’s perspective, the AP may also need telemetry from the STA. For example, AP 1 may subscribe to data from STA 1, such as signal measurements, observed throughput, or device state. The AP 1 may use the received data to optimize scheduling, allocate resources, or train AI/ML models for predictive network management. In some embodiments, peer STAs, such as STA 1 and STA 2, may require telemetry from one another in scenarios such as Wi-Fi Direct or cooperative applications, where devices benefit from exchanging state or context information directly.

In some embodiments, the subscription framework allows the subscriber, such as STA 1, to select from among different subscription types offered by the publisher, such as AP 1. These may include periodic subscriptions, on-change or event-triggered subscriptions, mixed subscriptions that combine periodic and on-change delivery, and AP-suggested subscriptions in which the AP proactively establishes telemetry flows it determines may benefit the STA. Once a subscription is established, the subscriber, such as AP 1, proceeds to publish data from the selected sources to the STA in accordance with the selected subscription types.

In some embodiments, the subscription framework also supports continuity across the ESS 130. For example, when a subscription is established between STA 1 and AP 1 in BSS 1, and STA 1 subsequently roams to AP 2 in BSS 2, the subscription may be maintained across the ESS without interruption. In such configurations, the subscription discovery phase may be performed at the ESS level, and the roaming STA (e.g., STA 1) may continue to receive telemetry from the new AP (e.g., AP 2) without repeating the subscription negotiation process.

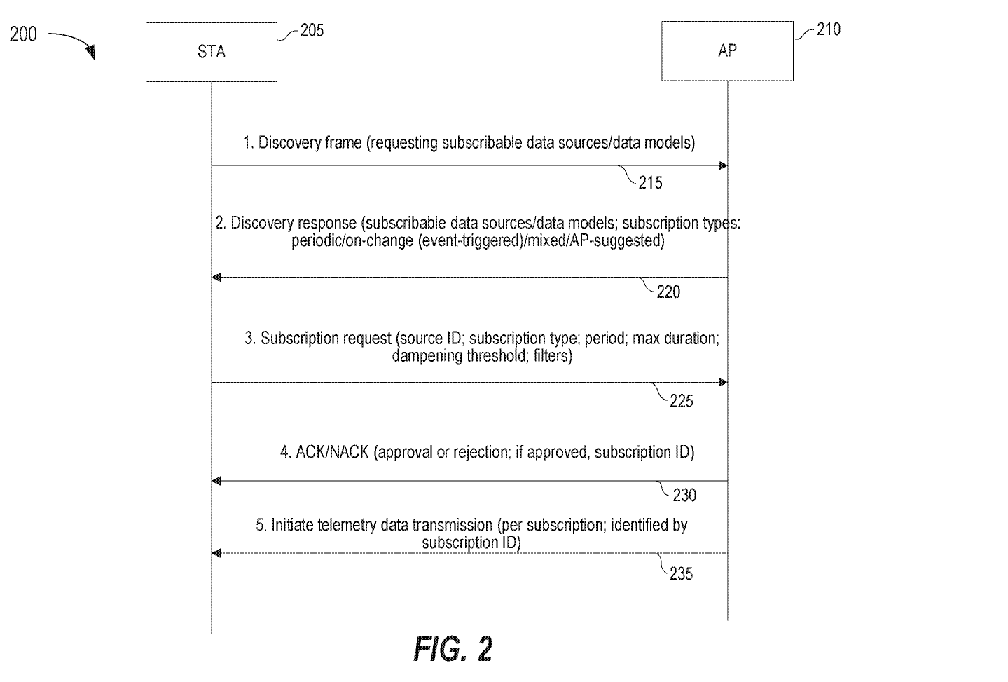

More details about establishing and managing the subscription-based telemetry between an AP and a STA (e.g., between AP 1 and STA 1), as well as between peer STAs (e.g., between STA 1 and STA 2), are discussed below with references to FIGS. 2-4.

FIG. 2 depicts an example interaction sequence 200 between a STA and an AP for establishing subscription-based telemetry, according to some embodiments of the present disclosure. STA 205 may correspond to a STA 125 depicted in FIG. 1, and AP 210 may correspond to an AP 110 depicted in FIG. 1. The STA 205 may be a single-link STA or a STA MLD, and the AP 210 may be a single-link AP or an AP MLD. The example sequence 200 depicts a scenario where the AP 210 acts as the publisher and the STA 205 acts as the subscriber. In other embodiments, the roles may be reversed, where the STA 205 acts as publisher and the AP as subscriber, or a subscription may be established between peer STAs.

At step 1 (depicted by 215), STA 205 transmits a discovery frame to AP 210, requesting information about subscribable data sources and any corresponding data models supported by the AP. In some embodiments, the discovery frame may be implemented as an action frame or another suitable frame type used for management exchanges.

In some embodiments, the discovery frame may further include a filter specification to reduce the scope of the discovery, such that the AP 210 only reports data sources or models matching the filter. In some embodiments, the filter may be implemented using an extended Berkeley Packet Filter (eBPF) program.

In response, at step (depicted by 220), AP 210 transmits a discovery response frame that identifies one or more available data sources or data models, and further indicates the subscription type supported for each source. These subscription types (also referred to in some embodiments as subscription capabilities) may include periodic subscriptions, on-change or event-triggered subscriptions, mixed subscriptions that combine periodic and on-change delivery, and AP-suggested subscriptions.

As used herein, the periodic subscription refers to telemetry updates that are published by the AP at defined time intervals. As used herein, the on-change or event-triggered subscription refers to telemetry updates that are published when the monitored value changes or a defined event occurs. As used herein, a mixed subscription may involve an on-change subscription with dampening, such that updates are suppressed unless a change exceeds a defined threshold. This approach avoids unnecessary transmissions for minor fluctuations. As used herein, an AP-suggested subscription refers to telemetry flows that are proactively initiated by the AP based on conditions determined by the AP, such as the operational state of the ESS (e.g., 130 of FIG. 1), the operational state of the BSS (e.g., 120 of FIG. 1), or a profile associated with the client device. In some embodiments, the AP may use trained machine learning models to predict a STA’s need and initiate the telemetry exchange.

In some embodiments, the AP provides the associated data sources or models within the discovery response. In some embodiments, the AP references the data sources and data models by providing a uniform resource locator (URL) to reduce signaling overhead. The supported data model may further include versioning information as well as limitations or deviations specifications to ensure compatibility and proper interpretation by the STA.

In embodiments where the discovery frame transmitted by STA 205 includes a filter specification, AP 210 reports only those data sources and models that satisfy the filter. This reduces the scope of the discovery exchange and minimizes signaling overhead. In embodiments where multicast subscriptions are supported, the discovery response may be transmitted using unicast frames and only to the associated STAs.

Following the discovery exchange, at step 3 (depicted by 225), STA 205 transmits a subscription request frame to AP 210. The request identifies one or more selected data sources or data models. For each selection, the STA 205 specifies the corresponding source identifier (ID), the selected subscription type (e.g., periodic, on-change or event-triggered, mixed, or AP-suggested), and the subscription period that defines the reporting interval. In some embodiments, the subscription request further defines a maximum subscription duration beyond which the subscription automatically expires. When an on-change subscription type is selected, the request may further specify an on-change dampening threshold, expressed either as an absolute value or as a percentage change, to suppress reporting of minor variations and ensure updates are only sent when meaningful or substantial changes occur.

After receiving the subscription request from STA 205, at step 4 (depicted by 230), AP 210 processes the request to determine whether it can be fulfilled. The AP 210 then transmits an acknowledgement (ACK) frame or a negative acknowledgement (NACK) back to the STA 205. The ACK approves the subscription request and includes a subscription identifier (ID) assigned by the AP 210 to the STA 205 for each approved data source or model. The subscription ID is used to manage the lifecycle of the subscription and to label subsequent telemetry messages.

The NACK communicates that the subscription request has not been accepted and may include a reason code identifying the basis for rejection, such as the requested data source being unavailable, the AP being under excessive load, or the subscription parameters falling outside supported limits.

Once an ACK frame approving the request is received, the subscription is considered established, and the workflow proceeds to the publishing stage. At step 5 (depicted by 235), AP 210 transmits telemetry data to STA 205 in accordance with the selected subscription type and parameters. For example, telemetry may be published at periodic intervals, upon detection of a change in monitored values, or in response to an event trigger, with each message referencing the assigned subscription identifier. When the subscription request includes an on-change dampening threshold, updates are transmitted only when the magnitude of change exceeds the specified threshold, which may be defined as an absolute value or a percentage. In some embodiments, the subscription request may also include a filter specification, such as an eBPF program, which the AP 210 executes to suppress publishing (or transmission) of data that does not satisfy the defined filter conditions.

The telemetry data itself may be transmitted in unicast frames addressed specifically to the subscribing STA, or in multicast frames when the subscription corresponds to multicast data models that do not include personal identifiable information (PII). To ensure privacy, in some embodiments, any telemetry comprising PII or STA-specific identifiers is transmitted only in unicast. Furthermore, to avoid information leakage, the availability of multicast subscription data models may be advertised only to associated STAs in unicast discovery responses, and multicast telemetry may be delivered in protected group-addressed frames. This ensures only authorized STAs within the BSS can access the multicast data.

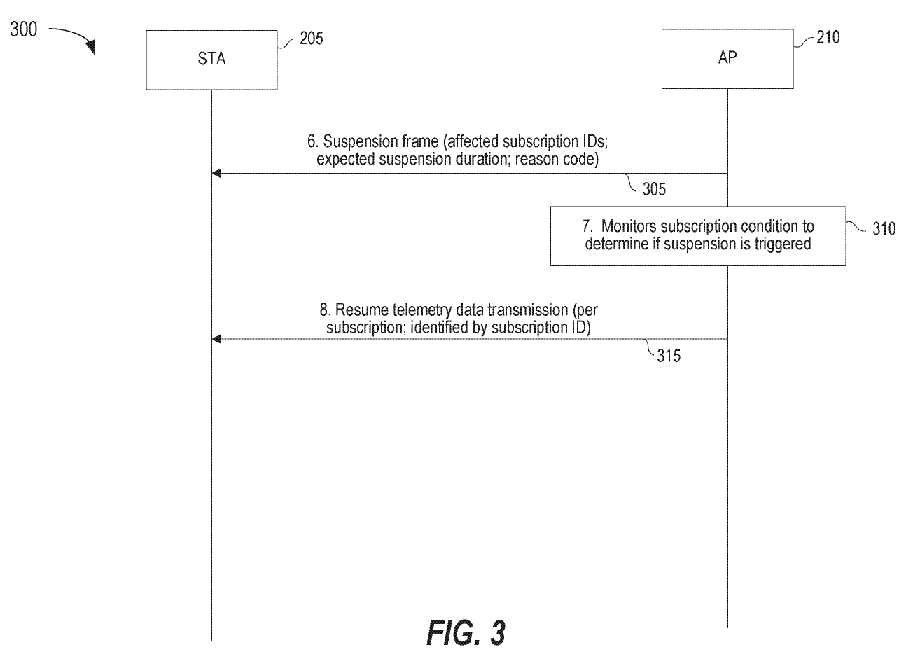

FIG. 3 depicts an example interaction sequence 300 between a STA and an AP when a subscription is temporarily suspended and subsequently resumed, according to some embodiments of the present disclosure.

The example interaction sequence 300 occurs after a subscription has been established between STA 205 and AP 210 as discussed above with reference to FIG. 2. AP 210 may temporarily place one or more subscriptions on hold for a variety of reasons, such as when a data source is temporarily unavailable, when the STA 205 enters a power-saving mode, or when the AP 210 experiences excessive load. As depicted in step 6 (depicted by 305), AP 210 transmits a suspension frame to STA 205. The suspension frame identifies the subscription identifier (ID) of the affected data sources or models, specifies the expected duration of the suspension period, and provides one or more reason codes indicating why telemetry publishing (or transmission) has been suppressed. Example reason codes include a data source becoming unavailable, high system load, or the client device being in low-power mode.

At step 7 (depicted by 310), AP 210 monitors the suspension condition internally. For example, the AP may track whether the affected data source becomes available again, whether system load returns to an acceptable threshold, whether the STA 205 returns from power-saving to an active mode, or whether any other triggered condition for suspension has been resolved. During the monitoring period, no telemetry data is transmitted for the affected subscription.

Once the suspension condition is resolved, the exchange proceeds to step 8 (depicted by 315), where AP 210 resumes telemetry publication (or transmission) to STA 205. The resumed publication (or transmission) is performed in accordance with the subscription parameters originally negotiated in the subscription request, such as the selected subscription type (periodic, on-change, mixed, or AP-suggested), reporting intervals, dampening thresholds, or filter specifications. Resumption stores the flow of telemetry without requiring STA 205 to reinitiate the subscription process.

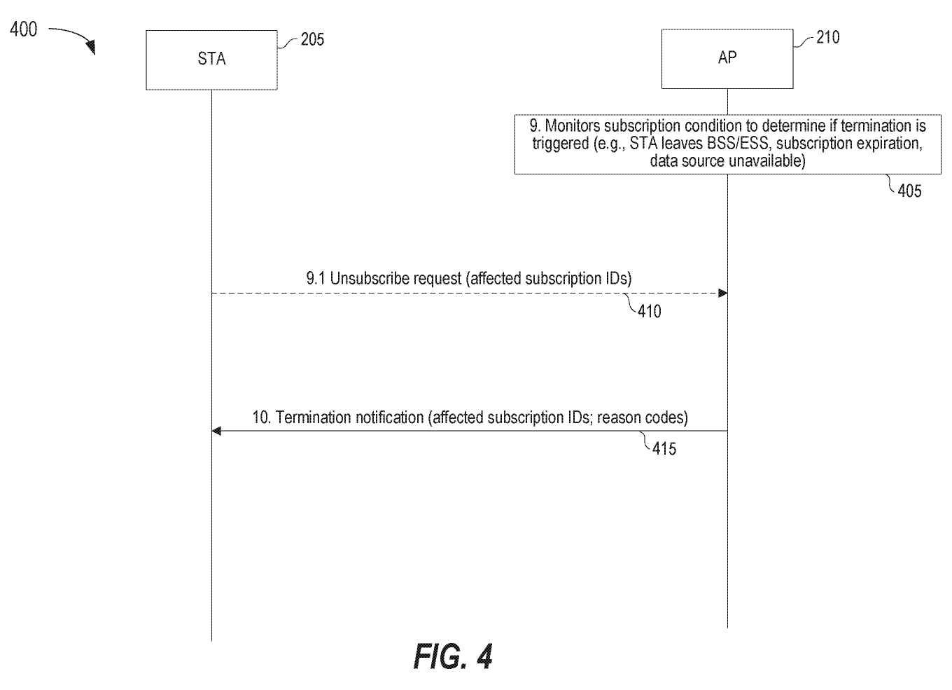

FIG. 4 depicts an example interaction sequence 400 between a STA and an AP for terminating a subscription, according to some embodiments of the present disclosure.

The example interaction sequence 400 occurs after a subscription has been established between STA 205 and AP 210 as discussed above with reference to FIG. 2, and depicts termination of the subscription. At step 9 (depicted by 405), AP 210 monitors the conditions associated with the subscription to determine whether termination is required. Such conditions may include STA 205 leaving the basic service set (BSS) (e.g., 120-1 of FIG. 1) or the extended service set (ESS) (e.g., 130 of FIG. 1), STA 205 transmitting an explicit termination request to AP 210, expiration of a subscription duration specified in the original subscription request, or detection of an internal condition such as the data source becoming unavailable.

In some embodiments, termination is initiated by the STA 205. At step 9.1 (depicted by 410), STA 205 optionally transmits an unsubscribed request frame to AP 210, identifying the subscription identifier (ID) of the subscription to be terminated.

At step 10 (depicted by 415), AP 210 transmits a termination notification to STA 205. The termination notification confirms that the subscription has been ended and includes the subscription ID for correlation. In some embodiments, the termination notification may also include a reason code that identifies why the subscription was terminated, such as STA disassociation, resource constraints, or data source unavailability.

FIGS. 2-4 collectively instruct a structured framework for managing subscription-based telemetry between a STA and an AP. The framework begins with subscription establishment as shown in FIG. 2, continues with temporary suspension and resumption as shown in FIG. 3, and concludes with termination as shown in FIG. 4. These figures together demonstrate how STA 205 and AP 210 may interact to negotiate, maintain, and conclude telemetry subscriptions in a wireless network.

In some embodiments, a subscription may be defined per basic service set (BSS), such that the subscription is valid only when the STA remains associated with a particular AP. In other embodiments, when an extended service set (ESS) (e.g., 130 of FIG. 1) exists, the subscription may be extended to span multiple BSSs (e.g., 120-1 and 120-2 of FIG. 1). In such configurations, when STA 205 roams from AP 210 in one BSS to another AP in the same ESS, the subscription can continue seamlessly without requiring a new negotiation. The discovery phase (step 1 in FIG. 2) may be performed once per ESS, and subsequent APs within that ESS may honor the subscription during roaming.

In some embodiments, to reduce signaling overhead, the data sources and data models advertised by AP 210 in the discovery response (step 2 in FIG. 2) may be referenced via a URL. The link allows STA 205 to retrieve the models and relevant parameters externally. These data models may further include versioning information and limitation or deviation specifications to ensure compatibility.

In some embodiments, multicast subscriptions may be supported. For example, AP 210 may publish telemetry from certain non-PII data sources to multiple STAs within the BSS using protected multicast frames. To avoid information leakage, the availability of such multicast data models is advertised to each STA only through unicast discovery frames, and any data including PII is delivered strictly through unicast.

In some embodiments, filtering is applied to subscriptions. For example, STA 205 may include a filter specification either in the discovery frame (step 1 of FIG. 2) or the subscription request frame (step 3 of FIG. 1), so that only matching data sources or telemetry events are reported. Such filters may be implemented using extended packet filter programs (e.g., eBPF programs) executed by AP 210.

In some embodiments, subscription may be defined as buffable. For example, STA 205 may request that AP 210 buffer telemetry data for a defined time duration (e.g., N seconds) or data size (e.g., K bytes). The STA 205 may then poll AP 210 when the STA 205 intends to retrieve the buffered data. In response, AP 210 provides the most recent N seconds or K bytes of telemetry information to STA 205.

Temporary suspension, as illustrated in FIG. 3, may occur when STA 205 enters a power-saving mode. In such cases, AP 210 may suspend publication (or transmission) until detecting that the STA has resumed active operation. AP 210 may then resume publication (or transmission) under the prior subscription parameters.

For defining and encoding data models, different formats may be used, such as Yet Another Next Generation (YANG). In some embodiments, a Management Information Base-like (MIB-like) encoding defined in Abstract Syntax Notation One (ASN.1) may be used.

In some embodiments, AP 210 automatically subscribes STA 205 to a set of basic telemetry feeds for proper ESS/BSS operation, such as network health or congestion metrics, using the AP-suggested subscription type. In some embodiments, an AP or a wireless local area network (LAN) controller (WLC) maintains profiles for STAs, for example, distinguishing IoT STAs, privacy-sensitive STAs, or fixed versus mobile devices. The AP or WLC then automatically subscribes each STA to telemetry feeds that are relevant to the STA’s profile.

In some embodiments, the AP presents STA 205 with a subscription menu adapted to the STA’s profile, allowing the STA to select desired feeds.

In some embodiments, the AP-suggested subscription type may be determined based on the operation of the BSS or ESS, or based on the profile of the client device. For example, the AP 210 may suggest a periodic subscription type to support BSS-level operational monitoring, such as reporting channel utilization at defined intervals. In another embodiment, the AP 210 may suggest an on-change subscription type for congestion events within the ESS, so that the STA 205 receives updates only when network conditions shift significantly. For IoT devices with limited bandwidth, the AP may suggest lightweight periodic telemetry. For mobile STAs running latency-sensitive applications, the AP may suggest event-triggered or mixed subscriptions to deliver timely updates without excessive overhead.

To further optimize efficiency, in some embodiments, AP 210 further implements a subscription bitmap. Each approved subscription is assigned a unique subscription ID (step 4 in FIG. 2), which AP 210 maps into a bitmap specific to STA 205. When multiple telemetry updates are ready, AP 210 may use a single frame to publish data for multiple subscriptions, indicating through the bitmap which subscription IDs are represented in the payload. Each payload element carries information for a specific subscription. The bitmap-based multiplexing supports a large number of overall subscription types while keeping the bitmap size small and conserving channel resources (e.g., based on the maximum allowed number of concurrent subscriptions).

The sequences shown in FIGS. 2-4 illustrate embodiments in which AP 210 acts as the publisher and STA 205 acts as the subscriber. In other embodiments, the roles may be reversed such that the AP acts as the subscriber and the STA acts as the publisher. For example, AP 210 may subscribe to telemetry from STA 205 relating to observed link-layer metrics (e.g., signal-to-noise (SNR), received signal strength indicator (RSSI), or packet error rate). The AP 210 may also subscribe to higher-level information, such as mobility state, battery level, or device health metrics, which the AP 210 can use for scheduling decisions, quality of service (QoS) enforcement, or AI/ML-based predictive optimization. In such configurations, the overall workflow remains similar to that shown in FIGS. 2-4, but the direction of certain messages is reversed. For example, AP 210 initiates discovery, STA 205 responds with its available data sources, AP 210 issues a subscription request, and STA 205 publishes telemetry accordingly.

In some embodiments, telemetry subscription may occur directly between peer STAs, such as in a Wi-Fi Direct configuration. In such embodiments, two STAs may establish a subscription so that one device publishes state information or sensor data directly to the other. For example, a smartphone may subscribe to telemetry from a wearable sensor (e.g., heart rate or motion data), or a laptop may subscribe to telemetry from an augmented reality (AR)/virtual reality (VR) headset relating to frame rendering latency or motion tracking events. The workflow in such configurations follows the same structure as depicted in FIGS. 2-4, with discovery, subscription request, acknowledgement, and data publication and transmission steps adapted to peer-to-peer communication instead of infrastructure mode.

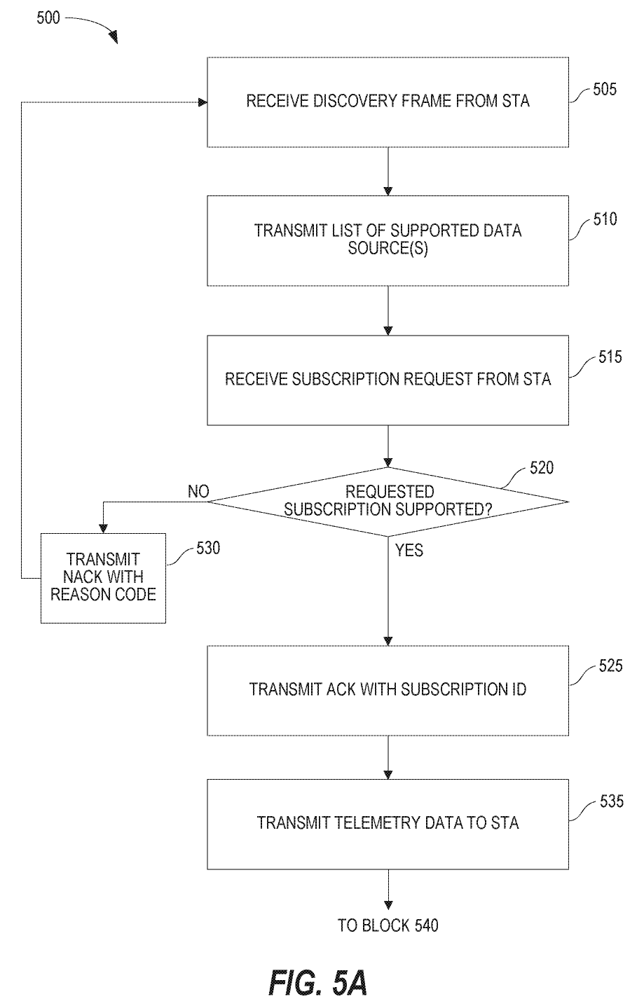

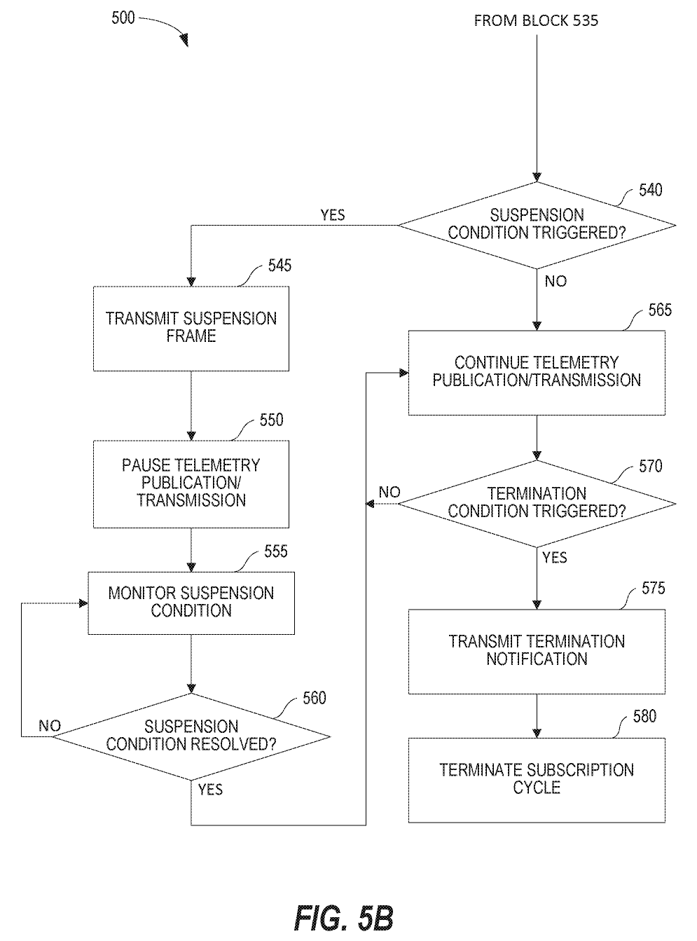

FIGS. 5A and 5B depict an example method 500 performed by an AP for establishing and managing subscription-based telemetry, according to some embodiments of the present disclosure. The example method may be performed by AP 110 as depicted in FIG. 1 or by AP 210 as depicted in FIGS. 2-4. In some embodiments, the example method 600 may be performed by a wireless LAN controller (WLC), a gateway, or another wireless network device configured to support subscription-based telemetry on behalf of an AP. Such devices may act as the publisher or subscriber in the workflow.

At block 505, the AP receives a discovery frame transmitted by a STA (e.g., STA 105 of FIG. 1 or STA 205 of FIGS. 2-4). The frame requests information about subscribable data sources or data models supported by the AP. In some embodiments, the STA may also include a filter specification in the discovery frame to reduce the scope of the discovery. For example, the STA may request only data sources relating to channel conditions or only those supporting a specific subscription type. When such a filter is provided, the AP processes the filter and excludes from its response any data sources or models that do not match the filter criteria.

At block 510, the AP transmits a discovery response to the STA. The discovery response advertises a list of data sources and associated data models, and specifies subscription types that may be supported, such as periodic, on-change or event-triggered, mixed (on-change with dampening), or AP-suggested subscription. In some embodiments, the AP may provide the data model in full or may reference the model using a URL. In some embodiments, the AP may include versioning and limitation specifications within the discovery response.

At block 515, the AP receives a subscription request from the STA. The request identifies selected data sources or models that were advertised in the AP’s discovery response. In some embodiments, for each selected data source or model, the request includes the corresponding source ID so that the AP can unambiguously match the request to a supported telemetry feed. In addition to identifying the source, the subscription request may specify the subscription type for each selection. Examples include periodic subscriptions, on-change or event-triggered subscriptions, mixed subscriptions that combine periodic updates with on-change reporting, or AP-suggested subscriptions.

In some embodiments, the subscription request may also provide a set of parameters to control how telemetry should be delivered. These may include a reporting period, a maximum duration, an on-change dampening threshold, and a filter specification.

In some embodiments, the subscription request may include additional metadata, such as a priority level to indicate the relative importance of the subscription. In some embodiments, the STA may request the AP to temporarily buffer telemetry data for later retrieval.

At block 520, the AP monitors the received subscription request and determines whether the requested data source or model, subscription type, and associated parameters can be supported. The determination may consider AP resource availability, subscription type compatibility, and data source status.

If the subscription is supported, the method proceeds to block 525, where the AP transmits an ACK to the STA approving the request, and assigns a subscription ID to track the subscription. In some embodiments, when more than one data source or model is subscribed to within a single request, the AP may assign a separate subscription ID for each approved subscription. This allows the AP to manage multiple subscriptions independently.

If the subscription is not supported, the method proceeds to block 530, where the AP transmits a NACK rejecting the request and includes a reason code, such as unsupported subscription type, invalid parameters, or insufficient resources.

At block 535, following an approved request, the AP begins transmitting (in unicast) or publishing (in multicast) telemetry data to the STA in accordance with the subscription parameters. Publication may occur periodically, upon detection of a change or event, or in mixed mode, and may carry the assigned subscription ID.

Multicast is used for data models that include non-PII, such as generalized network metrics or environmental statistics. In such cases, the AP may publish the same telemetry to multiple associated STAs simultaneously using protected multicast frames. To protect privacy, any telemetry including PII or STA-specific identifiers are excluded from multicast delivery and instead transmitted only in unicast to the subscribing STA. In addition, the AP may advertise the availability of multicast data models only to associated STAs via unicast discovery responses, which further reduces the risk of information leakage.

Referring to FIG. 5B, at block 540, the AP monitors conditions that may require temporary suspension of a subscription. Such suspension conditions may include, for example, a data source becoming temporarily unavailable, the AP reaching a load threshold, or the STA entering a power-saving state.

If a suspension condition is detected, the method moves to block 545, where the AP transmits a suspension frame to the STA. The suspension frame identifies the subscription IDs for the affected data sources or models. In some embodiments, the AP also specifies the expected duration of the suspension period, and provides one or more reason codes indicating the basis for suspension (e.g., data source being unavailable, excessive load, or STA being in low-power mode). If no suspension condition is detected, the method proceeds directly to block 565.

At block 550, the AP pauses telemetry publication (or transmission) for the affected sources or models. No telemetry updates are transmitted during the suspension period.

At block 555, the AP actively monitors the suspension condition to determine whether it has been resolved. More specifically, the AP may verify whether the data source has become available again, check whether system load has returned to an acceptable level, or detect whether the STA has returned from a power-saving mode to an active state.

At block 560, the AP evaluates whether the suspension condition has been resolved. If the condition persists, the method cycles back to block 555, where the AP continues monitoring. If the condition has been resolved, the method proceeds to block 565.

At block 565, the AP resumes (or continues) telemetry publication or transmission in accordance with the subscription parameters originally negotiated in the subscription request. For example, telemetry may again be published or transmitted at periodic intervals, upon change detection, or in event-triggered mode. The resumed flow of telemetry occurs without requiring the STA to reinitiate the subscription. In some embodiments, the AP may also transmit an explicit resumption notification frame to the STA, indicating that telemetry publication (or transmission) for a given subscription ID has restarted. In embodiments where filters (e.g., eBPF-based conditions) or dampening thresholds were part of the original subscription, those remain active upon resumption. In embodiments where buffering was requested, the AP may release buffered telemetry data accumulated during the suspension, such as delivering the most recent N seconds or K bytes once publication (or transmission) resumes.

At block 570, the AP evaluates whether a termination condition has been triggered for an active subscription. Termination conditions may include the STA leaving the BSS or ESS, the AP receiving an unsubscribe request frame from the STA, expiration of the subscription duration specified in the subscription request, or detection that the data source is permanently unavailable. If a termination condition is not triggered, the method cycles back to block 565, where telemetry publication (or transmission) continues in accordance with the subscription parameters.

If a termination condition is triggered, the method proceeds to block 575, where the AP transmits a termination notification to the STA. The termination notification identifies the subscription IDs of the affected data sources or models, and may further include a reason code specifying why the subscription was terminated, such as STA leaving BSS, unsubscribed request received, subscription expired, or data source unavailable.

At block 580, the AP ends the subscription lifecycle for the affected data sources or models. After termination, no telemetry updates are sent under the terminated subscription ID, and resources allocated to the subscription are released.

After termination at block 580, the AP may again monitor for new discovery frames or subscription requests from the same STA or from other STAs within the BSS. In some embodiments, the system may monitor suspension conditions and termination conditions simultaneously during the subscription lifecycle. The operations associated with block 540 and the operations associated with block 570 may be performed in parallel.

The method 500 applies to embodiments where the AP serves as the publisher and the STA serves as the subscriber. In embodiments where the AP is the subscriber and the STA is the publisher, the method may be adapted to include: (i) the AP initiates the discovery exchange by transmitting an action frame to the STA, requesting available telemetry sources; (ii) the STA responds with a discovery response advertising its data sources or models, such as link-layer measurements, device state, or sensor information; (iii) the AP transmits a subscription request frame selecting one or more of the advertised data sources, subscription types, and parameters; (iv) the STA replies with an ACK/NACK and, if approved, assigns subscription IDs; and (v) the STA publishes or transmits telemetry to the AP in accordance with the subscription parameters, subject to suspension and termination logic similar to that described with reference to FIGS. 5A and 5B.

In embodiments where the subscription is established directly between peer STAs, such as in Wi-Fi Direct configurations, the method may include: (i) one STA initiates discovery and transmits a discovery frame to another STA; (ii) the responding STA transmits a discovery response advertising its available data sources and supported subscription types; (iii) the initiating STA transmits a subscription request specifying desired data sources, subscription types, and parameters; (iv) the responding STA acknowledges the request with an ACK/NACK and assigns subscription IDs if approved; and (v) the publishing STA transmits or publishes telemetry directly to the subscribing STA, subject to the same suspension and termination logic similar to that described with reference to FIGS. 5A and 5B.

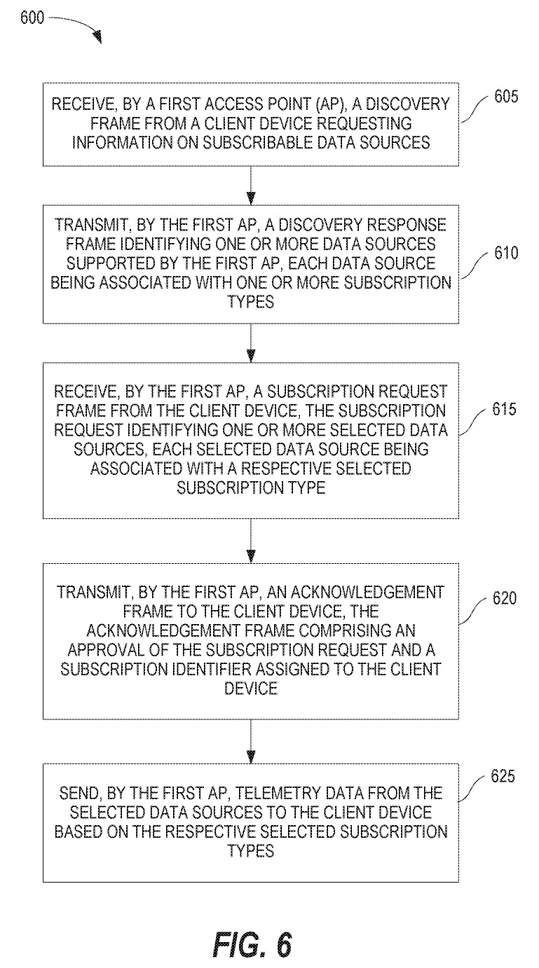

FIG. 6 is a block diagram depicting an example method for subscription-based telemetry establishment, according to some embodiments of the present disclosure.

At block 605, a first AP (e.g., 110-1 of FIG. 1 or 210 of FIGS. 2-4) receives a discovery frame from a client device (e.g., 125-1 of FIG. 1 or 205 of FIGS. 2-4) requesting information on subscribable data sources.

At block 610, the first AP transmits a discovery response frame identifying one or more data sources supported by the first AP, each data source being associated with one or more subscription types.

At block 615, the first AP receives a subscription request frame from the client device, the subscription request frame identifying one or more selected data sources, each selected data source being associated with a respective selected subscription type.

At block 620, the first AP transmits an acknowledgement frame to the client device, the acknowledgement frame comprising an approval of the subscription request frame and a subscription identifier assigned to the client device.

At block 625, the first AP sends telemetry data from the selected data sources to the client device based on the respective selected subscription types.

In some embodiments, the discovery response frame further identifies one or more data models corresponding to the data sources.

In some embodiments, the one or more subscription types comprise at least one of: a periodic type, an on-change type, a mixed type, wherein periodic publishing is combined with on-change publishing, or an AP-suggested type.

In some embodiments, for each of the selected data sources, the subscription request frame comprised at least one of: a source identifier, a subscription type, a subscription period, a subscription maximum duration, or an on-change dampening threshold.

In some embodiments, the first AP receives a second subscription request frame from the client device, and transmits a second acknowledgement frame to the client device, the second acknowledgement frame comprising a rejection of the second subscription request and a reason code identifying a basis for the rejection.

In some embodiments, the first AP transmits a suspension frame to the client device, the suspension frame identifying a temporary suppression of data transmission associated with at least one of the selected data sources.

In some embodiments, the suspension frame comprises the subscription identifier assigned to the client device, an expected suspension duration, and one or more reason codes.

In some embodiments, the first AP terminates the subscription with the client device in response to at least one of: the client device leaving a basic service set (BSS) of the first AP, receiving, by the first AP, an unsubscribe request frame from the client device, detecting, by the first AP, an expiration of a subscription duration indicated within the subscription request frame, or transmitting, by the first AP, a termination notification comprising a reason code.

In some embodiments, the client device receives, from a second AP, telemetry data from the selected data sources based on the respective selected subscription types, and the second AP and the first AP belong to a same extended service set (ESS).

In some embodiments, the discovery response frame comprises a uniform resource locator (URL) identifying the one or more selected data sources and the respective selected subscription types.

In some embodiments, the discovery response frame comprises a unicast frame and further identifies one or more multicast data models corresponding to the data sources.

In some embodiments, telemetry data from the data sources associated with the multicast data models is published by the first AP in protected multicast frames that exclude personally identifiable information.

In some embodiments, for one of the selected data sources, the subscription request frame further comprises one or more filter specifications, and each filter specification may define one or more conditions under which data from the selected data source is transmitted by the first AP to the client device.

In some embodiments, for one of the selected data sources, the subscription request frame further comprises a buffering parameter, and the buffering parameter instructs the first AP to buffer subscribed data for up to a defined time duration or data size.

In some embodiments, the first AP further buffers subscribed data from the selected data source up to the defined time duration or data size, and transmits the buffered data to the client device in response to receiving a poll from the client device.

In some embodiments, in response to detecting, by the first AP, that the client device has entered a power-saving mode, the first AP suspends transmission of telemetry data associated with the one or more selected data sources.

In some embodiments, in response to detecting that the client device has reinitiated an active mode, the first AP resumes transmission of telemetry data associated with the one or more selected data sources.

In some embodiments, the acknowledgement frame further comprises an AP-suggested subscription type for one of the selected data sources, the AP-suggested subscription type being determined by the AP based on at least one of basic service set (BSS) operation, extended service set (ESS) operation, or a client device profile.

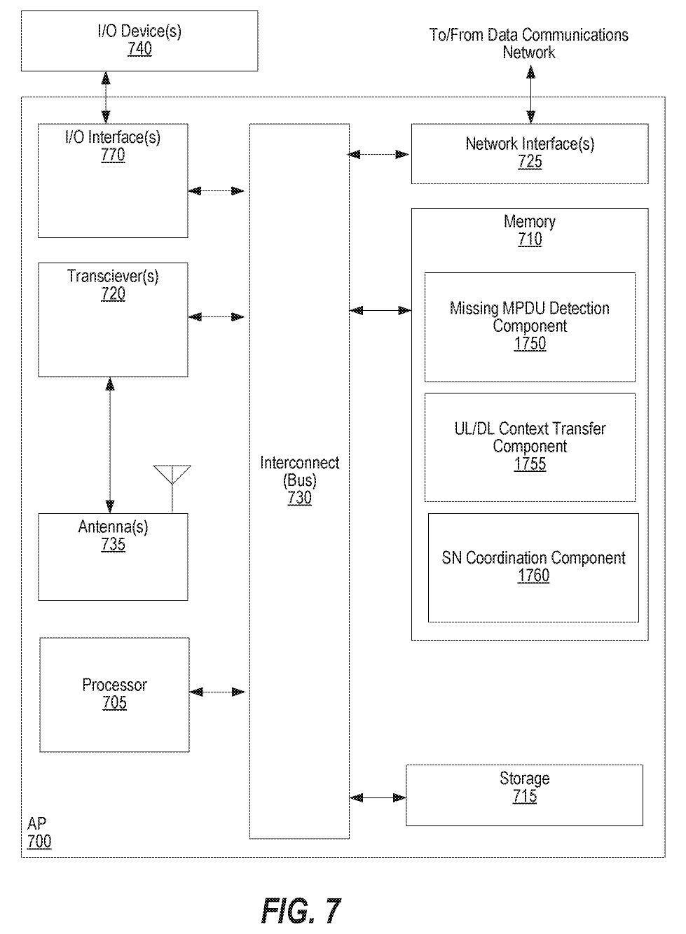

FIG. 7 depicts an example network device 700 configured to perform various aspects of the present disclosure, according to some embodiments of the present disclosure.

The example network device 700 may correspond to a publishing device in the subscription-based telemetry framework. In some embodiments, the publishing device is an AP (e.g., 110 of FIG. 1 or 210 of FIGS. 2-4) that provides telemetry feeds to associated client devices. In some embodiments, the publishing device may be a client device (STA) (e.g., 125 of FIG. 1 or 205 of FIGS. 2-4) that publishes telemetry to the AP. In some embodiments, the publishing device may be a peer STA in a direct subscription exchange, such as a Wi-Fi Direct configuration. In some embodiments, the network devices may correspond to other network elements configured to manage subscription-based telemetry. Such devices may include a network gateway, a physical or cloud-based server, or a wireless LAN controller (WLC).

As illustrated, the network device 700 includes a processor 705, memory 710, storage 715, one or more transceivers 720, one or more I/O interfaces 790, and one or more network interfaces 725. In some embodiments, I/O devices 740 are connected via the I/O interface(s) 780. Further, via the network interface 725, the network device 700 can be communicatively coupled with one or more other devices and components (e.g., via a network, which may include the Internet, local network(s), and the like). Each of the components is communicatively coupled by one or more buses 730. In some embodiments, one or more antennas 735 may be coupled to the transceivers 720 for transmitting and receiving wireless signals.

The processor 705 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 705 processes information received through the transceiver 720, I/O interfaces 790, and the network interfaces 725. The processor 705 retrieves and executes programming instructions stored in memory 710, as well as stores and retrieves application data residing in storage 715.

The storage 715 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 715 may store a variety of data for the efficient functioning of the system.

The memory 710 may include random access memory (RAM) and read-only memory (ROM). The memory 710 may store processor-executable software code containing instructions that, when executed by the processor 705, enable the network device 700 to perform various functions described herein for wireless communication.

As depicted, the memory 710 includes a telemetry management component 750, a filter engine 755, a telemetry publishing component 760, a multicast management component 765, and a buffer management component 770.

In one embodiment, the telemetry management component 750 is configured to handle subscription establishment, including processing discovery frames, generating discovery responses, receiving subscription requests, and issuing ACK/NACK frames.

In one embodiment, the filter engine 755 is configured to apply filter specifications provided by the STA (or other subscriber device), such as eBPF programs, to selectively determine which telemetry events or values should be published under an active subscription.

In one embodiment, the telemetry publishing component 760 is configured to transmit telemetry updates to STAs (or other subscriber devices) according to selected subscription types, including periodic, on-change, mixed, or AP-suggested subscriptions, and to support delivery in unicast or multicast frames.

In one embodiment, the multicast management component 765 is configured to support multicast subscriptions by delivering telemetry data models that do not include PII using protected group-addressed frames.

In one embodiment, the buffer management component 770 is configured to support bufferable subscriptions by storing telemetry data for a defined duration or size threshold, and to provide buffered data to an STA (or other subscriber device) in response to a retrieval request.

Although depicted as a discrete component for conceptual clarity, in some embodiments, the operations of the depicted components (and others not illustrated) may be combined or distributed across any number of components. Further, although depicted as software residing in memory 710, in some embodiments, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:receiving, by a first access point (AP), a discovery frame from a client device requesting information on subscribable data sources;transmitting, by the first AP, a discovery response frame identifying one or more data sources supported by the first AP, each data source being associated with one or more subscription types;receiving, by the first AP, a subscription request frame from the client device, the subscription request frame identifying one or more selected data sources, each selected data source being associated with a respective selected subscription type;transmitting, by the first AP, an acknowledgement frame to the client device, the acknowledgement frame comprising an approval of the subscription request frame and a subscription identifier assigned to the client device; andsending, by the first AP, telemetry data from the selected data sources to the client device based on the respective selected subscription types.

2. The method of claim 1, wherein the discovery response frame further identifies one or more data models corresponding to the data sources.

3. The method of claim 1, wherein the one or more subscription types comprise at least one of:a periodic type,an on-change type,a mixed type, wherein periodic publishing is combined with on-change publishing, or an AP-suggested type.

4. The method of claim 1, wherein for each of the selected data sources, the subscription request frame comprises at least one of:a source identifier,
a subscription type,a subscription period,a subscription maximum duration, or an on-change dampening threshold.

5. The method of claim 1, further comprising:receiving, by the first AP, a second subscription request frame from the client device; andtransmitting, by the first AP, a second acknowledgement frame to the client device, the second acknowledgement frame comprising a rejection of the second subscription request frame and a reason code identifying a basis for the rejection.

6. The method of claim 1, further comprising:transmitting, by the first AP, a suspension frame to the client device, the suspension frame identifying a temporary suppression of data transmission associated with at least one of the selected data sources.

7. The method of claim 6, wherein the suspension frame comprises the subscription identifier assigned to the client device, an expected suspension duration, and one or more reason codes.

8. The method of claim 1, further comprising:terminating, by the first AP, the subscription with the client device in response to at least one of:the client device leaving a basic service set (BSS) of the first AP,receiving, by the first AP, an unsubscribe request frame from the client device,detecting, by the first AP, an expiration of a subscription duration indicated within the subscription request frame, or 31
transmitting, by the first AP, a termination notification comprising a reason code.

9. The method of claim 1, wherein the client device receives, from a second AP, telemetry data from the selected data sources based on the respective selected subscription types, and the second AP and the first AP belong to a same extended service set (ESS).

10. The method of claim 1, wherein the discovery response frame comprises a uniform resource locator (URL) identifying the one or more selected data sources and the respective selected subscription types.

11. The method of claim 1, wherein the discovery response frame comprises a unicast frame and further identifies one or more multicast data models corresponding to the data sources.

12. The method of claim 11, wherein telemetry data from the data sources associated with the multicast data models is published by the first AP in protected multicast frames that exclude personally identifiable information.

13. The method of claim 1, wherein, for one of the selected data sources, the subscription request frame further comprises one or more filter specifications, and each filter specification defines one or more conditions under which data from the selected data source is transmitted by the first AP to the client device.

14. The method of claim 1, wherein, for one of the selected data sources, the subscription request frame further comprises a buffering parameter, and the buffering parameter instructs the first AP to buffer subscribed data for up to a defined time duration or data size.

15. The method of claim 14, further comprising:
buffering, by the first AP, subscribed data from the selected data source up to the defined time duration or data size, andtransmitting the buffered data to the client device in response to receiving a poll from the client device.

16. The method of claim 1, further comprising:in response to detecting, by the first AP, that the client device has entered a power-saving mode, suspending, by the first AP, transmission of telemetry data associated with the one or more selected data sources.

17. The method of claim 16, further comprising:in response to detecting, by the first AP, that the client device has reinitiated an active mode, resuming, by the first AP, transmission of telemetry data associated with the one or more selected data sources.

18. The method of claim 1, wherein the acknowledgement frame further comprises an AP-suggested subscription type for one of the selected data sources, the AP- suggested subscription type being determined by the AP based on at least one of basic service set (BSS) operation, extended service set (ESS) operation, or a client device profile.

19. A system of an access point (AP), comprising:one or more computer processors; andone or more memories collectively containing one or more programs, which, when executed by the one or more computer processors, perform an operation, the operation comprising:receiving a discovery frame from a client device requesting information on subscribable data sources;transmitting a discovery response frame identifying one or more data sources supported by the AP, each data source being associated with one or more subscription types;
receiving a subscription request frame from the client device, the subscription request frame identifying one or more selected data sources, each selected data source being associated with a respective selected subscription type;transmitting an acknowledgement frame to the client device, the acknowledgement frame comprising an approval of the subscription request frame and a subscription identifier assigned to the client device; andsending telemetry data from the selected data sources to the client device based on the respective selected subscription types.

20. One or more computer-readable media containing, in any combination, computer program code that, when executed by a computer system, performs an operation comprising:receiving, by a first access point (AP), a discovery frame from a client device requesting information on subscribable data sources;transmitting, by the first AP, a discovery response frame identifying one or more data sources supported by the first AP, each data source being associated with one or more subscription types;receiving, by the first AP, a subscription request frame from the client device, the subscription request frame identifying one or more selected data sources, each selected data source being associated with a respective selected subscription type;transmitting, by the first AP, an acknowledgement frame to the client device, the acknowledgement frame comprising an approval of the subscription request frame and a subscription identifier assigned to the client device; andsending, by the first AP, telemetry data from the selected data sources to the client device based on the respective selected subscription types.
